(19) United States
(12) Patent Application Publication
(10) Pub. No.: US 2007/0273715 A1
(43) Pub. Date: Nov. 29, 2007

(54) Electro-optical device and electronic apparatus

(75) Inventor: Nobuo Sugiyama, Suwa-shi (JP)

Correspondence Address: OLIFF & BERRIDGE, PLC, P.O. BOX 19928, ALEXANDRIA, VA, 22320, US

(73) Assignee: EPSON IMAGING DEVICES CORPORATION, AZUMINO-SHI (JP)

(21) Appl. No.: 11/783,722

(22) Filed: Apr. 11, 2007

(30) Foreign Application Priority Data
May 29, 2006 (JP) 2006-147714

(51) Int. Cl. G09G 5/10

(52) U.S. Cl. 345/690

(57) ABSTRACT

An electro-optical device includes a display panel having a plurality of data lines, a plurality of scanning lines, pixel electrodes arranged in corresponding intersections of the plurality of data lines and the plurality of scanning lines; a parallax barrier which is arranged on a surface of the display panel and which has slits in positions corresponding to boundaries of adjacent pixel electrodes; and a controller that controls data signals to be supplied to the plurality of data lines and scanning signals to be supplied to the plurality of scanning lines to thereby control magnitudes of potentials applied to the pixel electrodes and display images. When images are displayed and when it is determined that a potential to be applied to a certain pixel electrode is lower by a predetermined amount or more than a potential to be applied to a pixel electrode adjacent to the certain pixel electrode in a direction in which the scanning lines extend, the controller performs correction processing by adding a predetermined voltage to the potential to be applied to the certain pixel electrode. When it is determined that the potential to be applied to the certain pixel electrode is higher by a predetermined amount or more than the potential to be applied to the pixel electrode adjacent to the certain

### BACKGROUND

1. Technical Field

The present invention relates to electro-optical devices and electronic apparatuses which are suitably employed to display a variety of information.

2. Related Art

Known examples of electro-optical devices include a two-screen display device which provides different images for viewers in different view positions and a three-dimensional image display device which displays three-dimensional images. An example of a display method of such display devices includes a parallax barrier method. An image display device employing the parallax barrier method includes a liquid crystal display panel and a parallax barrier disposed on a display plane, which is a plane nearer to the viewers, of the liquid crystal display panel of the image display device. The parallax barrier has stripe openings at predetermined positions thereof. The stripe openings of the parallax barrier are formed such that, for example, when first and second images are provided for first and second viewers in different view positions, respectively, the first viewer can only see the first image and the second viewer can only see the second image. Furthermore, in a case where a three-dimensional image is provided for a viewer, the stripe openings of the parallax barrier are formed such that the viewer can see an image for the left eye with the left eye and an image for the right eye with the right eye.

However, generation of crosstalk gives an adverse effect on the image display device employing the parallax barrier method described above. The crosstalk means leakage of light emitted from one image to another image, which is caused by different factors. For example, in a case where first and second images are provided for first and second viewers in different view positions, respectively, the first viewer can see not only the first image but also part of the second image and the second viewer can see not only the second image but also part of the first image due to the generation of crosstalk. Furthermore, in a case where a three-dimensional image is provided for a viewer, the viewer can see with the left eye not only an image for the left eye but also part of an image for the right eye. Meanwhile, the viewer can see with the right eye not only the image for the right eye but also part of the image for the left eye.

JP-A-2004-312780 discloses a technique of reduction of crosstalk by raising the gray level of a background on the basis of an amount of necessary crosstalk correction predetermined by experimentally measuring a display on RGB color vectors which are input to individual pixels.

### SUMMARY

An advantage of some aspects of the invention is that, in an electro-optical device such as an image display device employing a parallax barrier method, crosstalk is reduced to improve display quality.

According to an aspect of the invention, there is provided an electro-optical device including a display panel having a plurality of data lines, a plurality of scanning lines, pixel electrodes arranged in corresponding intersections of the plurality of data lines and the plurality of scanning lines; a parallax barrier which is arranged on a surface of the display panel and which has slits in positions corresponding to boundaries of adjacent pixel electrodes; and a controller that controls data signals to be supplied to the plurality of data lines and scanning signals to be supplied to the plurality of scanning lines to thereby control magnitudes of potentials applied to the pixel electrodes and display images. When images are displayed and when it is determined that a potential to be applied to a certain pixel electrode is lower by a predetermined amount or more than a potential to be applied to a pixel electrode adjacent to the certain pixel electrode in a direction in which the scanning lines extend, the controller performs correction processing by adding a predetermined voltage to the potential to be applied to the certain pixel electrode, whereas when it is determined that the potential to be applied to the certain pixel electrode is higher by a predetermined amount or more than the potential to be applied to the pixel electrode adjacent to the certain pixel electrode, the controller performs correction processing by subtracting a predetermined voltage from the potential to be applied to the certain pixel electrode.

The electro-optical device is an image display device employing a parallax barrier method for performing two-screen display or three-dimensional image display, and includes a display panel, a parallax barrier, and a controller. The display panel is, for example, a liquid crystal display panel including a plurality of data lines, a plurality of scanning lines, and pixel electrodes arranged in corresponding intersections of the plurality of data lines and the plurality of scanning lines. The parallax has slits in positions corresponding to boundaries of adjacent pixel electrodes. The controller controls data signals to be supplied to the plurality of data lines and scanning signals to be supplied to the plurality of scanning lines to thereby control magnitudes of potentials applied to the pixel electrodes and display images. When images are displayed and when it is determined that a potential to be applied to a certain pixel electrode is lower by a predetermined amount or more than a potential to be applied to a pixel electrode adjacent to the certain pixel electrode in a direction in which the scanning lines extend, the controller performs correction processing by adding a predetermined voltage to the potential to be applied to the certain pixel electrode, whereas when it is determined that the potential to be applied to the certain pixel electrode is higher by a predetermined amount or more than the potential to be applied to the pixel electrode adjacent to the certain pixel electrode, the controller performs correction processing by subtracting a predetermined voltage from the potential to be applied to the certain pixel electrode. Accordingly, when two different images are displayed on a screen, in the electro-optical display device, the influence of crosstalk caused by display of one image during display of another image can be suppressed.

It is preferable that the predetermined voltage is a constant voltage.

According to another aspect of the invention, there is provided an electronic apparatus including the electro-optical device as a display unit.

According to a further aspect of the invention, there is provided a driving method of an electro-optical device including a display panel having a plurality of data lines, a plurality of scanning lines, pixel electrodes arranged in corresponding intersections of the plurality of data lines and the plurality of scanning lines; a parallax barrier which is arranged on a surface of the display panel and which has slits in positions corresponding to boundaries of adjacent pixel electrodes; and a controller that controls data signals to be supplied to the plurality of data lines and scanning signals to be supplied to the plurality of scanning lines to thereby control magnitudes of potentials applied to the pixel electrodes and display images, the driving method including performing, by the controller, correction processing by adding a predetermined voltage to the potential to be applied to the certain pixel electrode when images are displayed and when it is determined that a potential to be applied to a certain pixel electrode is lower by a predetermined amount or more than a potential to be applied to a pixel electrode adjacent to the certain pixel electrode in a direction in which the scanning lines extend; and performing, by the controller, correction processing by subtracting a predetermined voltage from the potential to be applied to the certain pixel electrode when it is determined that the potential to be applied to the certain pixel electrode is higher by a predetermined amount or more than the potential to be applied to the pixel electrode adjacent to the certain pixel electrode.

### BRIEF DESCRIPTION OF THE DRAWINGS

The invention will be described with reference to the accompanying drawings, wherein like numbers reference like elements.

FIG. 1 shows a sectional view illustrating an image display device according to an embodiment.

FIG. 2 shows a plan view illustrating a liquid crystal display panel of the image display device according to the embodiment.

FIG. 3 shows a schematic diagram illustrating a composite image formed from two images.

FIG. 4 shows a circuit diagram illustrating part of a configuration of driving circuits of the image display device according to the embodiment.

FIG. 5 shows an enlarged view of the composite image in a case where the influence of crosstalk is ignored.

FIG. 6 shows an enlarged view of the composite image in a case where the influence of crosstalk is considered.

FIG. 7 shows a flowchart illustrating a driving method of the image display device according to the embodiment.

FIG. 8 shows an enlarged view of the composite image after crosstalk is corrected.

FIG. 9 shows an example of an electronic apparatus to which the image display device of the embodiment is applied.

### DESCRIPTION OF EXEMPLARY EMBODIMENTS

Embodiments of the invention will now be described in detail hereinafter with reference to the accompanying drawings.

### Image Display Device

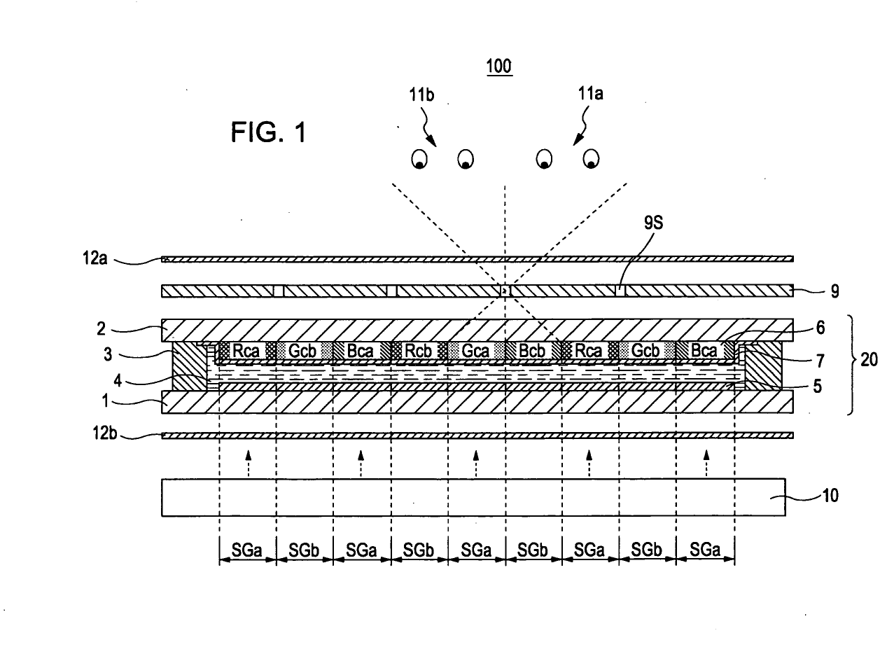

FIG. 1 shows a sectional view illustrating an image display device 100 according to an embodiment. The image display device 100 according to the embodiment is an image display device which employs a parallax-barrier method and which performs two-screen display for displaying different images to a plurality of viewers in different view positions. The image display device 100 has the same configuration as image display devices employing a parallax barrier method in the related arts.

As shown in FIG. 1, the image display device 100 according to the embodiment mainly includes a parallax barrier 9, a liquid crystal display panel 20, and an illuminating unit 10.

The liquid crystal display panel 20 is configured such that substrates 1 and 2 are attached to each other through a seal member 3. A space between the substrates 1 and 2 is filled by liquid crystal 4. The substrate 1 has pixel electrodes 5 disposed inside thereof so as to correspond to subpixels SGa and SGb each of which corresponds to one dot. The substrate 2 has color layers 6 which are provided for RGB color components and which serve as color filters and a counter electrode 7 disposed inside thereof. The color layers 6 for RGB color components are disposed in positions corresponding to the pixel electrodes 5 and the counter electrode 7 is disposed over the surface of the substrate 2.

The illuminating unit 10 is disposed in a rear side of the liquid crystal display panel 20. The illuminating unit 10 transmits light to illuminate the liquid crystal display panel 20. A rear polarizing plate 12b is disposed between the liquid crystal display panel 20 and the illuminating unit 10.

The liquid crystal display panel 20 has the parallax barrier 9 on a light-emitting side thereof. The parallax barrier 9 is configured as a panel having slits 9S disposed therein with predetermined intervals. Only the slits 9S in the parallax barrier 9 function as transmissive regions which allow light to be transmitted and the parallax barrier 9 itself functions as a light-shielding region which prevents light from being transmitted. The parallax barrier 9 is formed from two substrates and liquid crystal sandwiched therebetween. The transmissive regions, that is, the slits 9S, and the light-shielding region which prevents light from being transmitted are formed by controlling the orientation of the liquid crystal. The slits 9S are positioned so as to correspond to boundaries of the adjacent color layers 6 or correspond to boundaries of the adjacent pixel electrodes 5. A front polarizing plate 12a is disposed on a light-emitting side of the parallax barrier 9.

The light emitted from the illuminating unit 10 is incident to the liquid crystal display panel 20. After being transmitted through the color layers 6, the light is emitted from the liquid crystal display panel 20. The light emitted from the liquid crystal display panel 20 is incident through the slits 9S to a plurality of viewers 11a and 11b in different positions.

In the image display device 100 shown in FIG. 1, the color layers 6 for RGB color components which transmit light to be seen by the viewer 11a are represented by color layers Rca, Gca, and Bca, and the color layers 6 for RGB color components which transmit light to be seen by the viewer 11b are represented by color layers Rcb, Gcb, and Bcb. Accordingly, the subpixels SGa corresponding to the color layers Rca, Gca, and Bca are used in the liquid crystal display panel 20 as subpixels for RGB color components which transmit the light to be seen by the viewer 11a. Similarly, the subpixels SGb corresponding to the color layers Rcb, Gcb, and Bcb are used in the liquid crystal display panel 20 as subpixels for RGB color components which transmit the light to be seen by the viewer 11b.

For example, as shown by broken lines, light transmitted through the color layer Gca further passes through a slit 9S positioned between the color layers Gca and Bcb to thereby be seen by the viewer 11a. Similarly, light transmitted through the color layer Bcb further passes through the slit 9S to thereby be seen by the viewer 11b.

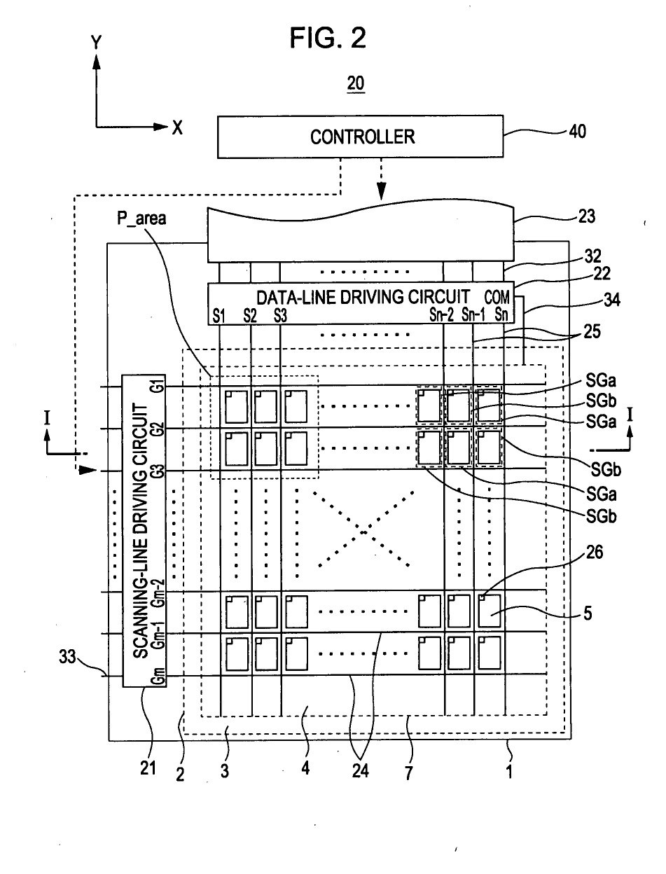

Configurations of driving circuits of the liquid crystal display panel 20 will now be described. FIG. 2 shows a plan view illustrating a liquid crystal display panel 20 included in the image display device 100 according to the embodiment. Note that FIG. 1 is the sectional view of the liquid crystal display panel 20 in the image display device 100 taken along a section line I-I′ of the plane view of the liquid crystal display panel 20 shown in FIG. 2 and the driving circuits are omitted in FIG. 1. In FIG. 2, the vertical direction (a column direction) of the drawing is defined as a Y direction and the horizontal direction (a row direction) of the drawing is defined as an X direction.

A plurality of scanning lines 24 and a plurality of data lines 25 are arranged in a matrix on an inner surface of the substrate 1. Switching elements 26 such as TFT (Thin Film Transistor) elements are disposed at corresponding intersections of the scanning lines 24 and the data lines 25. The pixel electrodes 5 are electrically connected to the switching elements 26.

Specifically, the substrate 1 is larger than the substrate 2 and has regions extending outwardly relative to the substrate 2 in the X direction and the Y direction. A scanning-line driving circuit 21 is arranged on an inner surface of the region extending in the X direction of the substrate 1 and a data-line driving circuit 22 is arranged on an inner surface of the region extending in the Y direction of the substrate 1.

The data lines 25 shown as data lines S1 to Sn (n: natural number) extend in the Y direction and are disposed with predetermined intervals therebetween in the X direction. The data lines 25 are electrically connected to the data-line driving circuit 22 at first ends thereof. The data-line driving circuit 22 is electrically connected to an FPC (Flexible Printed Circuit) 23 through lines 32. The FPC 23 is electrically connected to an external electronic apparatus. The data-line driving circuit 22 receives control signals supplied from a controller 40 of the external electronic apparatus through the FPC 23. The data-line driving circuit 22 supplies data signals to the data lines 25 shown as the data lines S1 to Sn in accordance with the control signals.

The scanning lines 24 shown as scanning lines G1 to Gm (m: natural number) extend in the X direction and are arranged with predetermined intervals therebetween in the Y direction. The scanning lines 24 are electrically connected to the scanning-line driving circuit 21 at first ends thereof. The scanning-line driving circuit 21 is electrically connected to lines 33. The lines 33 are electrically connected to the external electronic apparatus. The scanning-line driving circuit 21 receives control signals supplied from the controller 40 of the external electronic apparatus through the lines 33. The scanning-line driving circuit 21 sequentially supplies scanning signals to the scanning lines 24 shown as the data lines G1 to Gm in accordance with the control signals.

The counter electrode 7 is electrically connected to the data-line driving circuit 22 through a line 34 shown as COM. The data-line driving circuit 22 supplies driving signals through the line 34 to the counter electrode 7 in accordance with the control signals supplied from the external electronic apparatus whereby the counter electrode 7 is driven.

The scanning-line driving circuit 21 sequentially selects the scanning lines 24 in an exclusive manner in an order of the scanning lines G1, G2, G3, . . . , and Gm in accordance with the control signals supplied from the controller 40 and supplies the scanning signals to the selected scanning lines 24. The data-line driving circuit 22 supplies, in accordance with the control signals supplied from the controller 40, through the data lines 25 data signals based on display contents to the pixel electrodes 5 arranged in positions corresponding to the selected scanning lines 24. By means of the above, potentials are applied to the pixel electrodes 5 and the orientation of liquid crystal molecules of the liquid crystal 4 arranged between the pixel electrodes 5 and the counter electrode 7 is changed so that the liquid crystal display panel 20 enters a non-display mode or an intermediate-display mode and displays a desired image thereon. That is, the controller 40 supplies the control signals to the scanning-line driving circuit 21 and the data-line driving circuit 22 to control the scanning signals and the data signals to be supplied to the scanning lines 24 and the data lines 25, respectively, whereby a desired image can be displayed on the liquid crystal display panel 20.

The subpixels SGa and the subpixels SGb are alternately disposed in the X and Y directions. Accordingly, an image to be seen by the viewer 11a is displayed by changing the orientation of the liquid crystal molecules of the liquid crystal 4 arranged between the pixel electrodes 5 and the counter electrode 7 associated with the subpixels SGa. On the other hand, an image to be seen by the viewer 11b is displayed by changing the orientation of the liquid crystal molecules of the liquid crystal 4 arranged between the pixel electrodes 5 and the counter electrode 7 associated with the subpixels SGb.

### Configuration of Composite Image

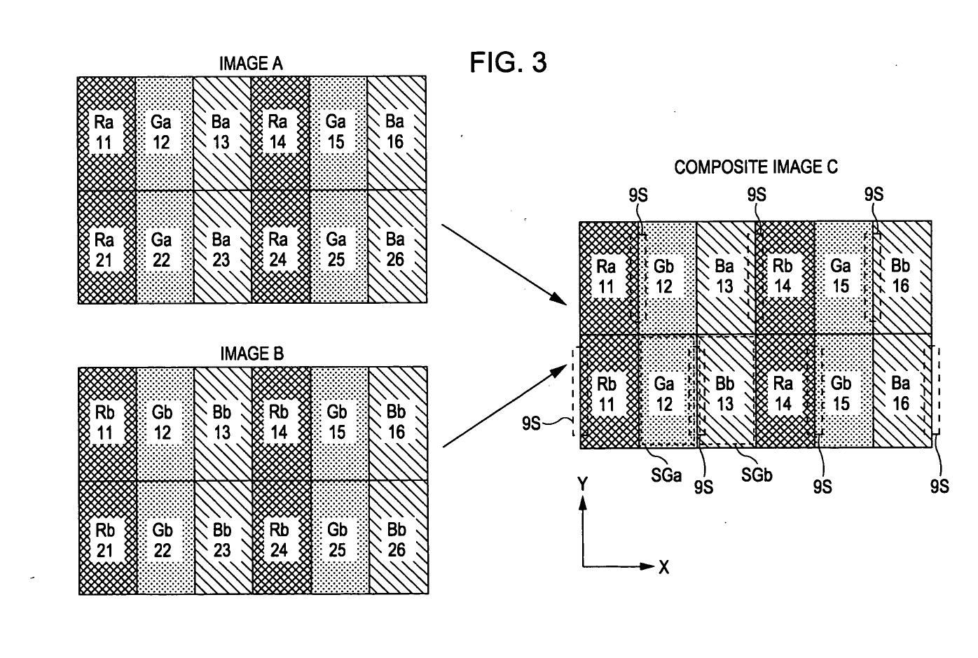

A composite image which is displayed by the image display device 100 according to the embodiment will now be described. FIG. 3 shows a schematic diagram illustrating an image A, an image B, and a composite image C generated using the image A and the image B. The image A is displayed for the viewer 11a and the image B is displayed for the viewer 11b. The composite image C is generated by compositing the image A and the image B and is displayed on a display screen of the liquid crystal display panel 20 in the image display device 100 according to the embodiment.

The image A includes unit images Ra11 to Ba26. Note that a unit image means an image to be displayed in a unit of a subpixel. The unit images having the reference characters Ra, Ga, and Ba are to be displayed in the subpixels SGa having corresponding RGB color components. That is, a unit image denoted by the reference character Ra is displayed in a subpixel SGa having an R color component, a unit image denoted by the reference character Ga is displayed in a subpixel SGa having a G color component, and a unit image denoted by the reference character Ba is displayed in a subpixel SGa having a B color component.

The image B includes unit images Rb11 to Bb26. The unit images having the reference characters Rb, Gb, and Bb are to be displayed in the subpixels SGb having corresponding RGB color components. That is, a unit image denoted by the reference character Rb is displayed in a subpixel SGb having an R color component, a unit image denoted by the reference character Gb is displayed in a subpixel SGb having a G color component, and a unit image denoted by the reference character Bb is displayed in a subpixel SGb having a B color component.

When the composite image C is generated using the image A and the image B, the controller 40 controls the unit images of the image A and the unit images of the image B to correspond to the subpixels SGa and the subpixels SGb. That is, as described above, since the subpixels SGa and the subpixels SGb are alternately arranged in the X and Y directions on the liquid crystal display panel 20, the controller 40 alternately composites the unit images of the image A and the unit images of the image B so as to correspond to the subpixels SGa and the subpixels SGb which are alternately arranged.

Specifically, when the composite image C is generated using the image A and the image B, the controller 40 uses unit images in a plurality of predetermined rows of the images A and B as unit images constituting the composite image C. In FIG. 3, the unit images Ra11 to Ba16 of the image A and the unit images Rb11 to Bb16 of the image B are used as the unit images constituting the composite image C. Unit images in rows other than the plurality of predetermined rows of the images A and B are not used as the unit images constituting the composite image C. As shown in FIG. 3, the unit images Ra21 to Ba26 of the image A and the unit images Rb21 to Bb26 of the image B are not used as the unit images constituting the composite image C.

As is apparent from the composite image C shown in FIG. 3, the controller 40 generates the composite image C by alternately arranging the unit images Ra11 to Ba16 of the image A and the unit images Rb11 to Bb16 of the image B so as to correspond to the subpixels SGa and the subpixels SGb alternately arranged.

The controller 40 determines potentials to be applied to the pixel electrodes 5 corresponding to the subpixels SGa and SGb on the basis of the gray levels of the unit images of the composite image C generated as described above and supplies control signals generated in accordance with the determined potentials to the scanning-line driving circuit 21 and the data-line driving circuit 22.

As described above, the composite image C shown in FIG. 3 is displayed in the liquid crystal display panel 20 of the image display device 100. In FIG. 3, the slits 9S of the parallax barrier 9 are shown on the composite image C by broken lines. The viewer 11a only sees the unit images Ra11, Ga12, Ba13, Ra14, Ga15, and Ba16, when seeing the composite image C through the slits 9S, so as to recognize the image A. On the other hand, the viewer 11b only sees the unit images Rb11, Gb12, Bb13, Rb14, Gb15, and Bb16, when seeing the composite image C through the slits 9S, so as to recognize the image B.

### Generation of Crosstalk

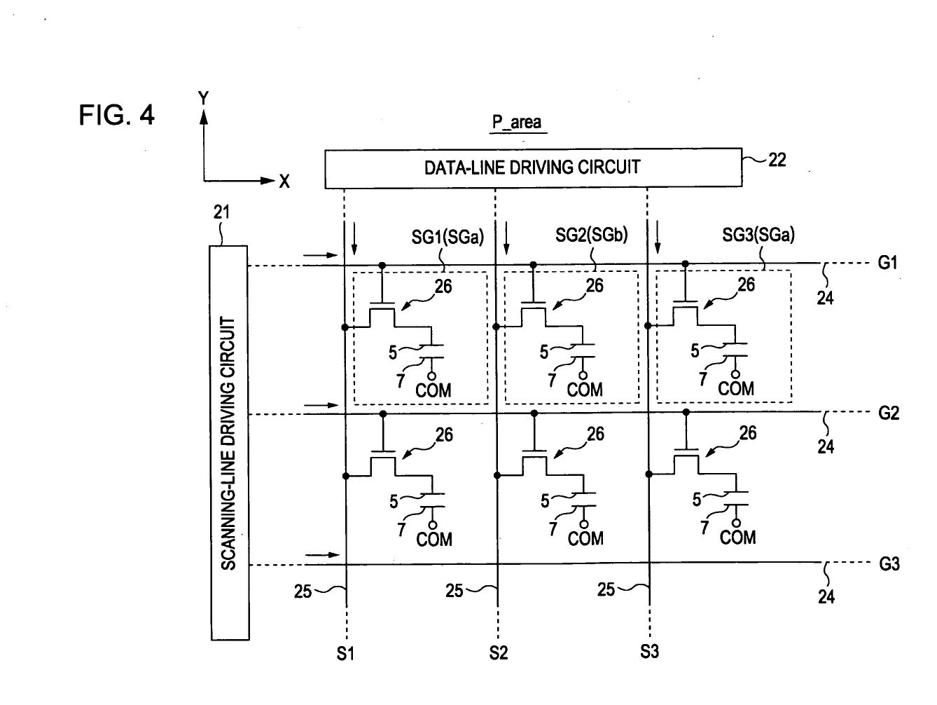

FIG. 4 shows a circuit diagram illustrating part of the driving circuit of the image display device 100. Specifically, FIG. 4 shows part of the driving circuit which is surrounded by a broken line and is indicated as P_area in FIG. 2. In FIG. 4, subpixels SG1 and SG3 correspond to the subpixels SGa and a subpixel SG2 corresponds to the subpixel SGb.

As described above, the scanning-line driving circuit 21 sequentially selects the scanning lines 24 in an exclusive manner in an order of the scanning lines G1, G2, G3, . . . , and Gm in accordance with the control signals supplied from the controller 40 and supplies the scanning signals to the selected scanning lines 24. The data-line driving circuit 22 supplies, in accordance with the control signals supplied from the controller 40, through the data lines 25 data signals based on display contents to the pixel electrodes 5 arranged in the positions corresponding to the selected scanning lines 24.

During this operation, the potentials of the pixel electrodes 5 of the predetermined subpixels shift due to potentials of pixel electrodes 5 adjacent, in a direction in which the scanning signals are supplied, to the pixel electrodes 5 corresponding to the predetermined subpixels.

Specifically, for example, in FIG. 4, in a case where a potential applied to the pixel electrode 5 of the subpixel SG1 is lower than that of the pixel electrode 5 of the subpixel SG2, the potential applied to the pixel electrode 5 of the subpixel SG1 decreases. On the other hand, in a case where the potential applied to the pixel electrode 5 of the subpixel SG1 is higher than that of the pixel electrode 5 of the subpixel SG2, the potential applied to the pixel electrode 5 of the subpixel SG1 increases.

Similarly, in FIG. 4, in a case where a potential applied to the pixel electrode 5 of the subpixel SG2 is lower than that of the pixel electrode 5 of the subpixel SG3, the potential applied to the pixel electrode 5 of the subpixel SG2 decreases. On the other hand, in a case where the potential applied to the pixel electrode 5 of the subpixel SG2 is higher than that of the pixel electrode 5 of the subpixel SG3, the potential applied to the pixel electrode 5 of the subpixel SG2 increases.

As described above, in the image display device 100, since potentials of the pixel electrodes 5 of predetermined subpixels shift in accordance with potentials of pixel electrodes 5 adjacent, in a direction in which scanning signals are supplied, to the pixel electrodes 5 of the predetermined subpixels, crosstalk is generated. Specifically, in a case where different images are provided for different viewers in different positions, that is, in a case where a first image is provided only for a first viewer and a second image is provided only for a second viewer, the first viewer recognizes the second image in the displayed first image whereas the second viewer recognizes the first image in the displayed second image.

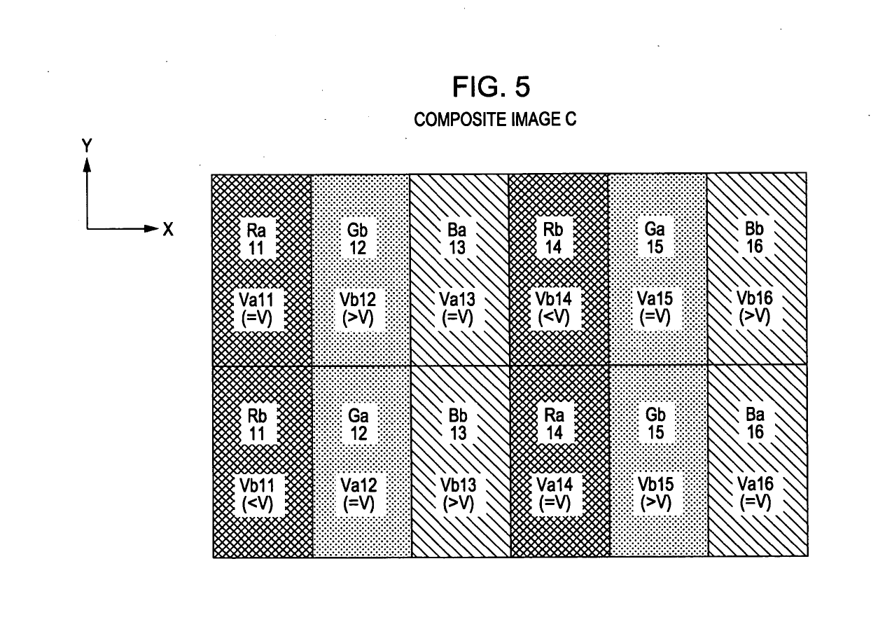

Referring to FIG. 5, the influence of the above-described generation of crosstalk on image display will be described. FIG. 5 shows an enlarged view of the composite image C described above. In FIG. 5, potentials Va11 to Va16 and Vb11 to Vb16 are applied to the pixel electrodes 5 of the subpixels SGa and SGb when the unit images Ra11 to Ba16 and Rb11 to Bb16 of the composite image C are displayed. In an example described hereinafter, the image A is entirely displayed in gray and the image B is entirely displayed in red. The influence of the generation of crosstalk on the composite image C will be described under this condition. Note that the liquid crystal display panel 20 is a liquid crystal display panel employing a normally-white mode.

Since the image A is entirely displayed in gray, the same gray levels are set to all of the unit images having R, G, and B color components of the image A. In the example shown in FIG. 5, when the unit images Ra11, Ga12, Ba13, Ra14, Ga15, and Ba16 included in the image A are displayed, all of the potentials Va11, Va12, Va13, Va14, Va15, and Va16 applied to the pixel electrodes 5 of the subpixels SGa are set to a potential V.

Since the image B is entirely displayed in red, gray levels of the unit images having the R color component are set higher than those of the unit images having the G and B color components. In the example shown in FIG. 5, of the unit images included in the image B, when the unit images Rb11 and Rb14 are displayed, the potentials Vb11 and Vb14 to be applied to the pixel electrodes 5 of the subpixels SGb are set lower than the potential V and when the unit images Gb12, Bb13, Gb15, and Bb16 are displayed, the potentials Vb12, Vb13, Vb15, and Vb16 to be applied to the pixel electrodes 5 of the subpixels SGb are set higher than the potential V.

In a case where the generation of the crosstalk is ignored, the viewer 11a recognizes the image A displayed in gray by setting the potentials Va11 to Va16 as described above, whereas the viewer 11b recognizes the image B displayed in red by setting the potentials Vb11 to Vb16 as described above.

However, in a case where the generation of crosstalk is considered, potentials of the pixel electrodes 5 of the subpixels SGa which are used to display the unit images of the image A shift in accordance with potentials of the pixel electrodes 5 of the subpixels SGb which are used to display the unit images of the image B and are adjacent, in a direction in which the scanning signals are supplied, to the unit images of the image A. In addition, the potentials of the pixel electrodes 5 of the subpixels SGb which are used to display the unit images of the image B shift in accordance with potentials of the pixel electrodes 5 of the subpixels SGa which are used to display the unit images of the image A and are adjacent, in a direction in which the scanning signals are supplied, to the unit images of the image B. Accordingly, the image A is influenced by the crosstalk generated due to the displayed image B whereas the image B is influenced by the crosstalk generated due to the displayed image A.

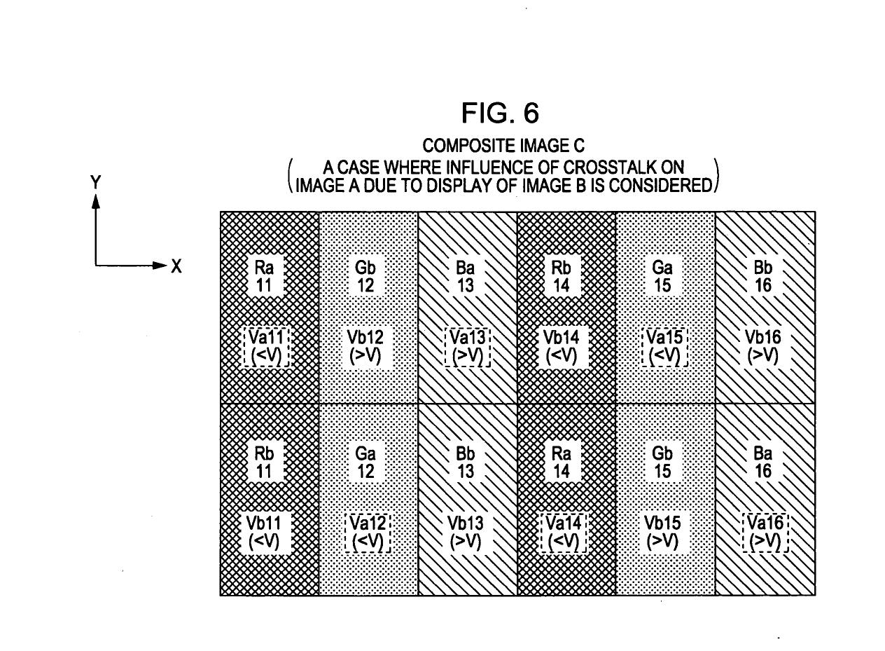

Referring to FIG. 6, as an example, a case where the image A is influenced by the crosstalk generated due to the displayed image B will now be described. FIG. 6 shows an enlarged view of the composite image C which is the same as that shown in FIG. 5. However, the composite image C shown in FIG. 6 is different from that shown in FIG. 5 in that potentials of the pixel electrodes 5 of the subpixels SGa which are used to display the unit images of the image A and which have shifted due to the crosstalk generated due to the displayed image B are indicated by broken lines.

In a case where the crosstalk generated due to the displayed image B is ignored, as described above, when the image A is displayed in gray, all of the potentials Va11, Va12, Va13, Va14, Va15, and Va16 are set to the potential V as shown in FIG. 5.

However, in FIG. 5, the potential Va11 (=V) of the pixel electrode 5 of the subpixel SGa which is used to display the unit image Ra11 is lower than the potential Vb12 (>V) of the pixel electrode 5 of the subpixel SGb which is used to display the unit image Gb12 adjacent to the unit image Ra11. Therefore, as shown in FIG. 6, the potential Va11 decreases due to the influence of the potential Vb12 to be lower than the potential V at the time of actual display.

In FIG. 5, the potential Va12 (=V) of the pixel electrode 5 of the subpixel SGa which is used to display the unit image Ga12 is lower than the potential Vb13 (>V) of the pixel electrode 5 of the subpixel SGb which is used to display the unit image Bb13 adjacent to the unit image Ga12. Therefore, as shown in FIG. 6, the potential Va12 decreases due to the influence of the potential Vb13 to be lower than the potential V at the time of actual display.

In FIG. 5, the potential Va13 (=V) of the pixel electrode 5 of the subpixel SGa which is used to display the unit image Ba13 is higher than the potential Vb14 (<V) of the pixel electrode 5 of the subpixel SGb which is used to display the unit image Rb14 adjacent to the unit image Ba13. Therefore, as shown in FIG. 6, the potential Va13 increases due to the influence of the potential Vb14 to be higher than the potential V at the time of actual display.

Similarly, at the time of actual display, the potential Va14 of the pixel electrode 5 of the subpixel SGa which is used to display the unit image Ra14 decreases to be lower than the potential V, the potential Va15 of the pixel electrode 5 of the subpixel SGa which is used to display the unit image Ga15 decreases to be lower than the potential V, and the potential Va16 of the pixel electrode 5 of the subpixel SGa which is used to display the unit image Ba16 increase to be higher than the potential V.

That is, when the image A is actually displayed, the potentials of the pixel electrodes used for R and G color components decrease and those of the pixel electrodes used for the B color component increase in the liquid crystal display panel 20 employing a normally-white method. Accordingly, when the image A is actually displayed, the gray levels of the R and G color components increase and the gray level of the B color component decrease. Therefore, the image A to be displayed in gray is actually displayed in yellow because of the influence of the crosstalk generated due to the displayed image B.

The influence of the crosstalk generated due to the displayed image A on the image B is explained similarly as described above.

In FIG. 5, the potential Vb11 (<V) of the pixel electrode 5 of the subpixel SGb which is used to display the unit image Rb11 is lower than the potential Va12 (=V) of the pixel electrode 5 of the subpixel SGa which is used to display the unit image Ga12 adjacent to the unit image Rb11. Therefore, the potential Vb11 decreases due to the influence of the potential Va12 at the time of actual display.

In FIG. 5, the potential Vb12 (>V) of the pixel electrode 5 of the subpixel SGb which is used to display the unit image Gb12 is higher than the potential Va13 (=V) of the pixel electrode 5 of the subpixel SGa which is used to display the unit image Ba13 adjacent to the unit image Gb12. Therefore, the potential Vb12 increases due to the influence of the potential Va13 at the time of actual display.

In FIG. 5, the potential Vb13 (>V) of the pixel electrode 5 of the subpixel SGb which is used to display the unit image Bb13 is higher than the potential Va14 (=V) of the pixel electrode 5 of the subpixel SGa which is used to display the unit image Ra14 adjacent to the unit image Bb13. Therefore, the potential Vb13 increases due to the influence of the potential Va14 at the time of actual display.

Similarly, at the time of actual display, the potential Vb14 of the pixel electrode 5 of the subpixel SGb which is used to display the unit image Rb14 decreases due to the influence of an adjacent subpixel SGa, the potential Vb15 of the pixel electrode 5 of the subpixel SGb which is used to display the unit image Gb15 increases due to the influence of an adjacent subpixel SGa, and the potential Vb16 of the pixel electrode 5 of the subpixel SGb which is used to display the unit image Bb16 increases due to the influence of an adjacent subpixel SGa.

That is, when the image B is actually displayed, the gray level of the R color component increases and the gray levels of the B and G color components decrease in the liquid crystal display panel 20 employing a normally-white method. Therefore, color of the image B to be displayed, which is red, is emphasized because of the influence of the crosstalk generated due to the displayed image A.

### Correction of Crosstalk

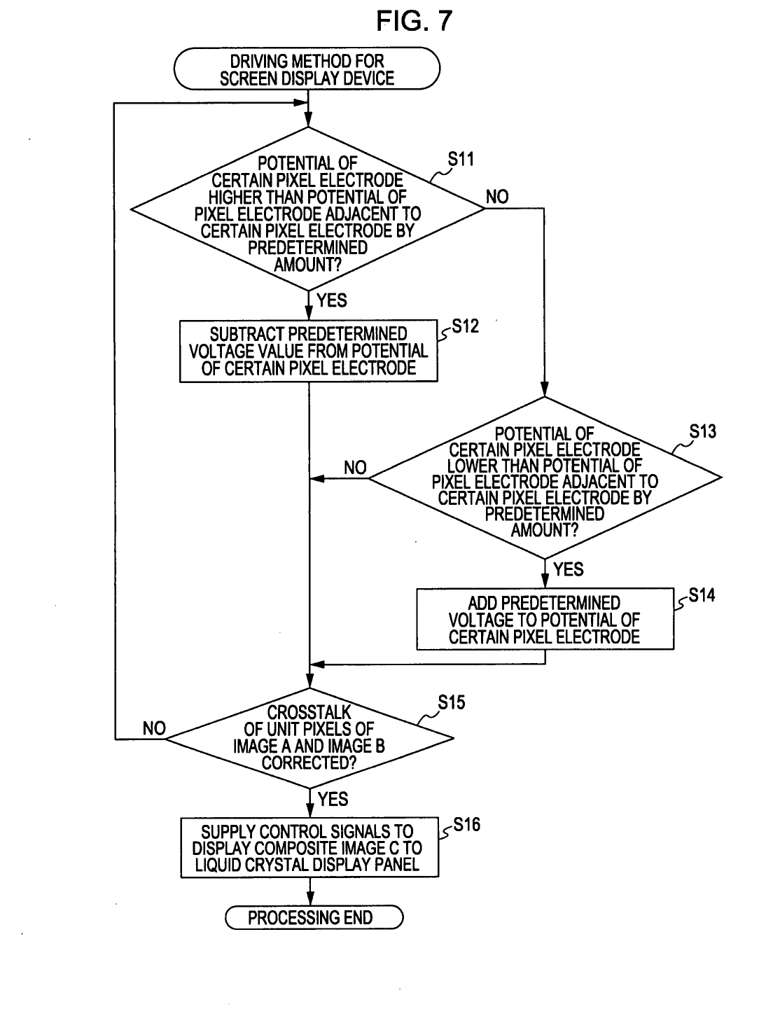

In the image display device 100 according to the embodiment, the controller 40 corrects potentials applied to certain pixel electrodes using predetermined voltages in advance on the basis of potentials applied to pixel electrodes adjacent to the certain pixel electrodes in a direction in which scanning lines extend whereby the influence of the crosstalk generated as described above is suppressed. Referring to a flowchart shown in FIG. 7, a driving method of the image display device 100 according to the embodiment for performing crosstalk correction processing will now be described in detail.

The controller 40 performs crosstalk correction processing on, for example, an image A which is one of images constituting the composite image C. The controller 40 determines whether a potential of a pixel electrode 5 used to display a certain unit image of the image A is higher, by a predetermined amount or more than that of a pixel electrode 5 used to display a unit image of the image B, which is adjacent to the certain unit image of the image A (step S11).

Specifically, the controller 40 obtains a potential to be applied to a pixel electrode 5 of a subpixel SGa used to display a certain unit image of the image A in accordance with a gray level of the certain unit image. Then, the controller 40 obtains a potential to be applied to a pixel electrode 5 of a subpixel SGb used to display a unit image of the image B which is adjacent to the certain unit image of the image A in accordance with a gray level of the unit image of the image B which is adjacent to the certain unit image of the image A. Thereafter, the controller 40 determines whether the potential to be applied to the pixel electrode 5 of the subpixel SGa used to display the certain unit image of the image A is higher by a predetermined amount or more than the potential to be applied to the pixel electrode 5 of the subpixel SGb used to display the unit image of the image B adjacent to the certain unit image of the image A.

When it is determined that the potential to be applied to the pixel electrode 5 used to display the certain unit image of the image A is higher by a predetermined amount or more than the potential to be applied to the pixel electrode 5 used to display the unit image of the image B adjacent to the certain unit image of the image A (step S11; Yes), the controller 40 performs crosstalk correction processing. In the crosstalk correction processing, the controller 40 subtracts a predetermined voltage value from the potential to be applied to the pixel electrode 5 used to display the certain unit image (step S12), and proceeds to step S15.

When it is determined in step S11 that the potential to be applied to the pixel electrode 5 used to display the certain unit image of the image A is not higher by a predetermined amount or more than the potential to be applied to the pixel electrode 5 used to display the unit image of the image B adjacent to the certain unit image of the image A (step S11; No), the controller 40 determines whether the potential to be applied to the pixel electrode 5 used to display the certain unit image of the image A is lower by a predetermined amount or more than the pixel electrode 5 used to display the unit image of the image B adjacent to the certain unit image of the image B (step S13).

When the controller 40 determines in step S13 that the potential to be applied to the pixel electrode 5 used to display the certain unit image of the image A is not lower by the predetermined amount than the potential to be applied to the pixel electrode 5 used to display the unit image of the image B adjacent to the certain unit image of the image A, that is, when the potential to be applied to the pixel electrode 5 used to display the certain unit image of the image A is substantially the same as the potential to be applied to the pixel electrode 5 used to display the certain unit image of the image A, that is, when the difference between the potential to be applied to the pixel electrode 5 used to display the certain unit image of the image A and the potential to be applied to the pixel electrode 5 used to display the unit image of the image B adjacent to the certain unit image of the image A is so small that the influence of crosstalk is negligible, the controller 40 proceeds to step S15 (step S13; No).

When the controller 40 determines in step S13 that the potential to be applied to the pixel electrode 5 used to display the certain unit image of the image A is lower by the predetermined amount or more than the potential to be applied to the pixel electrode 5 used to display the unit image of the image B adjacent to the certain unit image of the image A (step S13; Yes), the controller 40 performs crosstalk correction processing. In this crosstalk correction processing, the controller 40 adds a predetermined voltage value to the potential to be applied to the pixel electrode 5 used to display the certain unit image (step S14) and proceeds to step S15. The controller 40 performs step S11 to step S15 for all of the unit images of the image A.

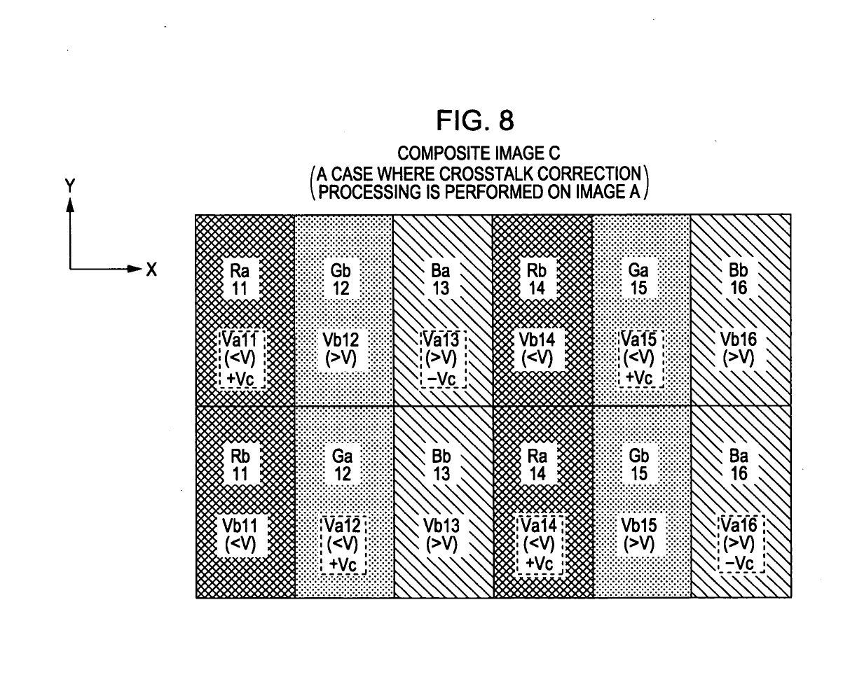

FIG. 8 shows an enlarged view of the composite image C after the crosstalk correction processing is performed on all of the unit images of the image A. In FIG. 8, a voltage Vc is a predetermined amount of voltage to be added to or subtracted from the potentials applied to the pixel electrodes 5 in the crosstalk correction processing.

As shown in FIG. 6, at the time of actual display, the potential Va11 decreases due to the influence of the potential vb12 to be lower than the potential V. Accordingly, the controller 40 adds the voltage Vc to the potential Va11 in advance as shown in FIG. 8. The potential Va12 decreases, at the time of actual display, due to the influence of the potential Vb13 to be lower than the potential V. Accordingly, the controller 40 adds the voltage Vc to the potential Va12 in advance as shown in FIG. 8. The potential Va13 increases, at the time of actual display, due to the influence of the potential Vb14 to be higher than the potential V. Accordingly, the controller 40 subtracts the voltage Vc from the potential Va13 in advance as shown in FIG. 8.

Similarly, at the time of actual display, the potential Va14 decreases due to the influence of the adjacent pixel electrode 5 of the subpixel SGb to be lower than the potential V, the potential Va15 decreases due to the influence of the adjacent pixel electrode 5 of the subpixel SGb to be lower than the potential V, and the potential Va16 increases due to the influence of the adjacent pixel electrode 5 of the subpixel SGb to be higher than the potential V. Accordingly, the controller 40 adds the voltage Vc to the potentials Va14 and Va15 and subtracts the voltage Vc from the potential Va16 in advance.

Since the controller 40 performs the crosstalk correction processing on the image A in advance, at the time of actual display, potentials of the pixel electrodes corresponding to R and G color components which decrease due to the influence of crosstalk increase and potentials of pixel electrodes of the image B which increase due to the influence of crosstalk decrease. Accordingly, when the image A is displayed, the controller 40 controls the potentials Va11 to Va16 to approximate to the potential V so that the image A is displayed in gray.

Referring again to FIG. 7, in step S15, the controller 40 determines whether the crosstalk correction processing has been performed on all of the unit images of the image A and the image B, that is, whether the crosstalk correction processing described above has been performed on the image B in addition to the image A. When it is determined that the crosstalk correction processing has not been performed on the unit images of the image B (step S15; No), the controller 40 returns to step S11 and step S11 to S14 are repeated for the unit images of the image B.

When the controller 40 determines in step S15 that the crosstalk correction processing has been performed on the unit images of the image A and the image B (step S15; Yes), control signals to display the composite image C generated using the image A and the image B are supplied to the scanning-line driving circuit 21 and the data-line driving circuit 22 of the liquid crystal display panel 20, the composite image C is displayed on the liquid crystal display panel 20 (step S16), and the crosstalk correction processing is terminated.

As described above, when the images are displayed and it is determined that a potential to be applied to a certain pixel electrode is lower by a predetermined amount or more than a potential to be applied to a pixel electrode adjacent to the certain pixel electrode in a direction in which the scanning lines extend, the controller 40 performs correction processing by adding a predetermined voltage to the potential to be applied to the certain pixel electrode. On the other hand, when it is determined that the potential to be applied to a certain pixel electrode is higher by a predetermined amount or more than the potential to be applied to the pixel electrode adjacent to the certain pixel electrode, the controller 40 performs correction processing by subtracting a predetermined voltage from the potential to be applied to the certain pixel electrode. Accordingly, in the image display device 100 according to the embodiment, generation of crosstalk is suppressed and display quality is improved.

### Modification

The image display device according to the foregoing embodiment performs two-screen display but the invention is not limited to this. The invention may be employed for three-dimensional image display. In this case, the potentials applied to pixel electrodes used to display unit images of an image for the right eye are influenced by crosstalk generated due to potentials applied to pixel electrodes used to display unit images of an image for the left eye which are adjacent to the unit images of the image for the right eye. Similarly, the potentials applied to the pixel electrodes used to display the unit images of the image for the left eye are influenced by crosstalk generated due to the potentials applied to the pixel electrodes used to display the unit images of the image for the right eye which are adjacent to the unit images of the image for the left eye. However, since the image display device employs the method described above, the crosstalk generated between an image for the left eye and an image for the right eye is suppressed.

### Electronic Apparatus

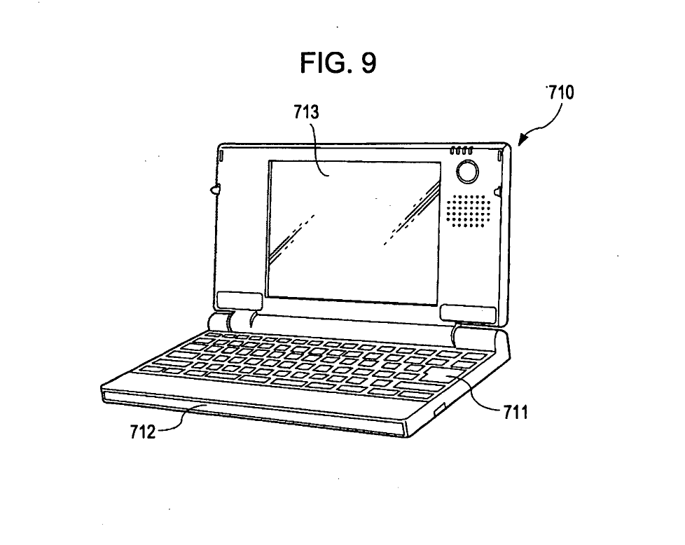

An example of an electronic apparatus to which the image display device 100 according to the foregoing embodiment is used will now be described in detail with reference to FIG. 9.

A portable personal computer (a so-called laptop computer) is described as an example of an electronic apparatus to which the image display device 100 according to the embodiment is used as a display unit. FIG. 9 shows a perspective view illustrating a configuration of the personal computer. As shown in FIG. 9, a personal computer 710 includes a body 712 having a keyboard unit 711 and a display unit 713 which is the image display device 100 according to the embodiment.

The image display device 100 according to the embodiment is suitably used as display units for liquid crystal TV sets and car navigation apparatuses. For example, when the image display device 100 according to the embodiment is used as a display unit of a car navigation apparatus, the display unit may display an image of a map for a viewer sitting on a driver seat and display video images such as a movie for a viewer sitting on a passenger seat.

Note that examples of electronic apparatuses to which the image display device 100 according to the embodiment can be used include video-tape recorders having a viewfinder or a monitor directly viewed by a user, pagers, personal digital assistances, calculators, cellular phones, word processors, work stations, video phones, POS (Point of Sales) terminals, and digital still cameras.

The entire disclosure of Japanese Patent Application No. 2006-147714, filed May 29, 2006 is expressly incorporated by reference herein.

What is claimed is:

1. An electro-optical device comprising:
a display panel having a plurality of data lines, a plurality of scanning lines, pixel electrodes arranged in corresponding intersections of the plurality of data lines and the plurality of scanning lines;
a parallax barrier which is arranged on a surface of the display panel and which has slits in positions corresponding to boundaries of adjacent pixel electrodes; and
a controller that controls data signals to be supplied to the plurality of data lines and scanning signals to be supplied to the plurality of scanning lines to thereby control magnitudes of potentials applied to the pixel electrodes and display images,
wherein, when images are displayed and when it is determined that a potential to be applied to a certain pixel electrode is lower by a predetermined amount or more than a potential to be applied to a pixel electrode adjacent to the certain pixel electrode in a direction in which the scanning lines extend, the controller performs correction processing by adding a predetermined voltage to the potential to be applied to the certain pixel electrode, whereas when it is determined that the potential to be applied to the certain pixel electrode is higher by a predetermined amount or more than the potential to be applied to the pixel electrode adjacent to the certain pixel electrode, the controller performs correction processing by subtracting a predetermined voltage from the potential to be applied to the certain pixel electrode.

2. The electro-optical device according to claim 1, wherein the predetermined voltage is a constant voltage.

3. An electronic apparatus comprising:
the electro-optical device set forth in claim 1 used as a display unit.

4. A driving method of an electro-optical device including a display panel having a plurality of data lines, a plurality of scanning lines, pixel electrodes arranged in corresponding intersections of the plurality of data lines and the plurality of scanning lines; a parallax barrier which is arranged on a surface of the display panel and which has slits in positions corresponding to boundaries of adjacent pixel electrodes; and a controller that controls data signals to be supplied to the plurality of data lines and scanning signals to be supplied to the plurality of scanning lines to thereby control magnitudes of potentials applied to the pixel electrodes and display images, the driving method comprising:
performing, by the controller, correction processing by adding a predetermined voltage to the potential to be applied to the certain pixel electrode when images are displayed and when it is determined that a potential to be applied to a certain pixel electrode is lower by a predetermined amount or more than a potential to be applied to a pixel electrode adjacent to the certain pixel electrode in a direction in which the scanning lines extend; and
performing, by the controller, correction processing by subtracting a predetermined voltage from the potential to be applied to the certain pixel electrode when it is determined that the potential to be applied to the certain pixel electrode is higher by a predetermined amount or more than the potential to be applied to the pixel electrode adjacent to the certain pixel electrode.
